(19) United States
(12) Patent Application Publication
(10) Pub. No.: US 2002/0038251 A1
(43) Pub. Date: Mar. 28, 2002

(54) System and method for print-on-demand communications campaigns for motivation programs

(75) Inventors: Maddy Sheprow, Fenton, MO (US); Ellen M. Cox, Fenton, MO (US); Brian F. Fitzpatrick, Fenton, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Maritz Inc.

(21) Appl. No.: 10/000,680

(22) Filed: Oct. 31, 2001

Related U.S. Application Data
(60) Provisional application No. 60/244,641, filed on Oct. 31, 2000.
(60) Provisional application No. 60/204,461, filed on May 16, 2000.

(51) Int. Cl. G06F 17/60

(52) U.S. Cl. 705/14

(57) ABSTRACT

An on-line motivation website implements a motivation program to motivate a participant by selecting and providing an award and a communications campaign element. A fulfillment program provides the selected award. A program creates a printed version of the selected communications campaign element for off-line presentation.

### CROSS REFERENCE TO RELATED APPLICATIONS

This application is based upon U.S. Provisional Patent Application No. 60/204,461, entitled METHOD AND SYSTEM FOR ELECTRONICALLY SELECTING, MODIFYING, AND OPERATING A MOTIVATION AWARDS PROGRAM, filed May 16, 2000, now abandoned, naming Fitzpatrick et al. as inventors, U.S. patent application Ser. No. 09/840,648, entitled METHOD AND SYSTEM FOR ELECTRONICALLY SELECTING, MODIFYING, AND OPERATING A MOTIVATION AWARDS PROGRAM, filed Apr. 23, 2001, naming Fitzpatrick et al. as inventors, and U.S. Provisional patent application Ser. No. 60/244,641, entitled SYSTEM AND METHOD FOR PRINT-ON-DEMAND COMMUNICATIONS CAMPAIGNS FOR MOTIVATION PROGRAMS, filed Oct. 31, 2000, naming Sheprow et al. as inventors. The entirety of such patent applications are incorporated by reference herein.

### BACKGROUND OF THE INVENTION

1. Field of the Invention

The present invention relates to the field of motivation programs. In particular, this invention relates to allowing a customer to motivate a participant by selecting on-line a communications campaign element and by presenting off-line to the participant the selected communications campaign element.

2. Description of the Prior Art Motivation programs (or campaigns, hereinafter, “programs”) provide companies (hereinafter, “customers”) with a method for attracting, retaining, awarding, and recognizing employees, members, volunteers, contractors, distribution-channel personnel, and other customers (hereinafter, “participants”). For more information regarding such programs, refer to: FILTER PROCESSOR AND METHOD FOR IMPLEMENTING A PROGRAM, U.S. Pat. No. 5,956,695 by Carrithers et al., assigned to Maritz Inc., incorporated herein by reference.

There is a need for an on-line system which provides customers with an integrated motivation package including an award and a related communications campaign element customizable by customers to be provided to participants as an integrated motivation package at various times throughout the program. There is also a need for a system which allows printing of customized cards or recognition certificates directly from a website to be presented with an award to a participant. There is also a need for a system which provides printable communications for use with on-line motivation programs by the customer or by the participant.

For these reasons, a system for allowing a customer to motivate a participant by using an on-line motivation program is desired to address one or more of these and other needs.

### SUMMARY OF THE INVENTION

It is an object of this invention to provide an on-line method and system which provides customers with the ability to select on-line an integrated motivation package including an award and communications campaign elements customizable by customers. The package may be provided to participants by the customers as an integrated motivation package at various times throughout the program. The communications campaign elements comprise promotional communications, cards and/or certificates, for example, which are printed as needed and provided off-line to the participant.

It is another object of this invention to provide a method and system which allows awards selected on-line by a customer to be presented to participants of the customer and which allows printing of customized cards or certificates directly from a website to be presented off-line to participants.

It is an object of this invention to provide a method and system for providing customizable, printable communications campaign elements for presentation and use off-line.

According to one aspect of the invention, a system comprises an on-line motivation website for implementing a motivation program allowing a customer to motivate a participant by selecting and providing to the participant an award and a printable communications campaign element. A fulfillment program provides the selected award to the participant either directly or through the customer. A printing program associated with the website creates a printed version of the selected communications campaign element for off-line presentation to the participant.

According to another aspect of the invention, a method comprises providing an on-line motivation program for allowing a customer to motivate a participant by providing an award to the participant; and allowing a customer to select at least one communications campaign element associated with the motivation program for off-line presentation to the participant.

According to another aspect of the invention, a method allows a customer to motivate a participant by presenting to the participant one of a plurality of motivation packages customized by the customer. The method comprises the steps of allowing the customer to select via a website accessible on-line one of a plurality of motivation documents to be presented to the participant and to select via the website accessible on-line one of a plurality of motivation awards to be presented to the participant; allowing the customer to print the selected motivation document at a location designated by the customer or a location designated by the participant wherein the selected motivation document includes customized text indicating the motivation award and/or text indicating the participant's name; and implementing the delivery of the selected motivation award to the customer or to the participant.

According to another aspect of the invention, a system allows a customer to motivate a participant with an on-line motivation program. The system comprises plurality of communications campaign elements in electronic format; a website accessible on-line by the customer for allowing the customer to select one of the communications campaign elements to be presented to the participant; and software responsive to the customer's on-line selections for printing the selected communications campaign elements at a location designated by the customer or a location designated by the participant, wherein the printed communications campaign element is provided to the participant and wherein the printed communications campaign elements includes text indicating the motivation and/or text indicating the participant's name.

In another form, the invention comprises a motivation program comprising a first program for permitting a customer to select on-line a motivation award for a participant and for permitting the customer to select on-line a communications campaign element for the participant; a second program for arranging to have the selected motivation award delivered to the customer or to the participant; and a third program for printing the selected communications campaign element at a designated location for delivery off-line to the participant.

In yet another form, the invention is method for allowing a customer to motivate participants. The method comprises the steps of allowing the customer to select via a website accessible on-line a category of campaigns and/or motivational programs; allowing the customer to select one of a plurality of motivation documents related to the selected category, the selected document to be presented to the participants, and allowing the customer to print the selected motivation document at a location designated by the customer or a location designated by the participant receiving the document wherein the selected motivation document includes customized text relating to motivation of the participant and/or text indicating the name of the participant receiving the document.

In another form, the invention is a promotional campaign system for allowing a customer to motivate participants. The system comprises a website accessible to the customer on-line for allowing the customer to select a category of campaigns and/or motivational programs and select one of a plurality of motivation documents related to the selected category, the selected document to be presented to at least some of the participants. Software allows the customer to print the selected motivation document at a location designated by the customer or a location designated by the participant receiving the document wherein the selected motivation document includes customized text relating to motivation of the participant and/or text indicating the name of the participant receiving the document.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of one preferred embodiment of the invention illustrating the main aspects.

FIG. 2 is a flow chart of one preferred embodiment of the invention in which the customer selects and customizes a motivation package.

Corresponding reference characters indicate corresponding parts throughout the drawings.

### DETAILED DESCRIPTION OF PREFERRED EMBODIMENTS

In one form, the invention includes an on-line motivation program which allows a customer to motivate a participant. For example, the invention may comprise an on-line motivation program including one or more motivating communications campaign elements (CCE) for off-line presentation and an optional motivation award. A customer selects on-line and presents off-line to the participant to be motivated at least one communications campaign element. Optionally, the element may be associated with the motivation award. The invention includes a print-on-demand capability for the communications campaign elements to replace or supplement any on-line communications which are part of the motivation program.

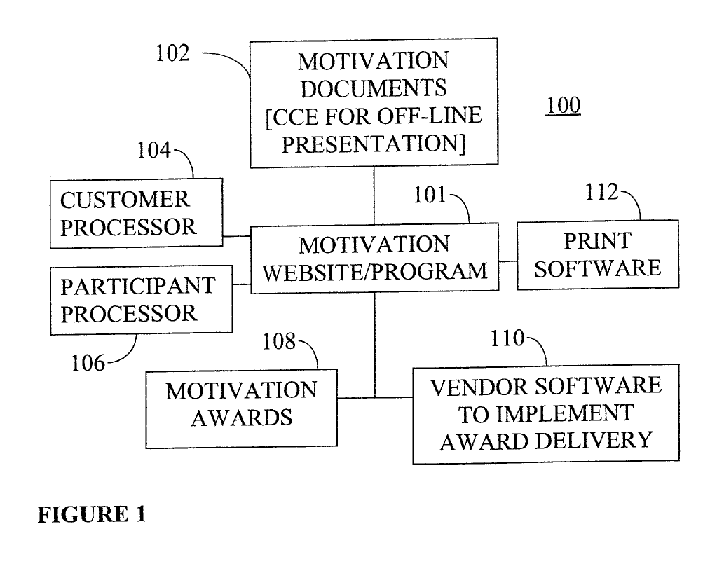

Referring to FIG. 1, a block diagram illustrating one preferred embodiment of the invention. In general, the invention relates to on-line print-on-demand communications campaigns for motivation programs. The invention (hereinafter referred to as “system 100”) allows a customer to motivate a participant by presenting to the participant one of a plurality of motivation packages customized by the customer. Each customer is generally a business or other entity having a plurality of participants such as employees, contractors, members, volunteers, distribution-channel people, vendors, consumers or other related people or businesses. The customer is interested in providing a motivation package to its participants to recognize and award them for certain activities or performance. The desired performance includes, but is not limited to, achieving sales quotas, reaching a service anniversary date, or acquiring new skills.

The motivation package is selected on-line by the customer and includes a motivation document 102 or one or more other motivating communications campaign elements selected on-line and delivered off-line to the participant. The campaign communications elements include text-provided promotional communications, cards or certificates to which the customer can add personalized messages to recognize the participants. The customer or participant can print the motivation documents 102 to a printing device selected by the customer immediately after purchase or throughout the program. The print-on-demand availability applies to the motivation documents 102 and other communications campaign elements including, but not limited to, site proposals, invoices, and white papers (e.g., expert articles).

In one preferred embodiment, the customer purchases the motivation package (document 102 and award 108) by selecting and customizing a document and by ordering an award which may be related or referred to in the selected document. The customer prints the motivation document 102 at the time of purchase or sometime thereafter. After the customer receives the ordered motivation award 108 and has printed the motivation document 102, the customer presents to the participant both the award and document as an integrated motivation package. Thus, motivation packages can be used in conjunction with award, incentive, or motivation programs or retention and retaining strategies or the like.

With reference to FIG. 1, the system 100 includes an on-line motivation program or website 101 for allowing the customer to select and customize a motivation package via a customer processor 104. The website 101 allows the customer to select and purchase on-line a communications package which includes one of the motivation documents 102 to be presented to the participant off-line and to select one of the motivation awards 108 to be presented to the participant. From the motivation website 101, the customer can access a library of motivation documents 102, a collection of motivation awards 108, print software 112 (which may be a plug in), and vendor software 110. The customer processor 104 can be part of any device which is capable of transmitting and receiving data, including, but not limited to, personal computers, laptop computers, handheld personal digital assistants, and cellular telephones.

The library of motivation documents 102 are preferably in digital format or another electronic format for access by computer processors. Motivation documents 102 include, but are not limited to, promotional campaigns, cards and certificates. Promotional campaigns provide motivation throughout the program and include a recommended delivery schedule (i.e., announcement piece, postcards, mailers, winner's list, etc.). Cards are the traditional greeting cards for events such as holidays, birthdays, and anniversaries. Certificates, or other motivation certificates or award and recognition certificates, provide motivation for events relating to the performance, achievement, and hard work of the participants. The certificates are suitable for framing. The customer optionally designates in the motivation document 102 text to personalize provided content, such as indicating the name of the participant and/or the reason for the award and/or refers to the selected award such as by giving information about the award or identifying the award.

In one preferred embodiment of the invention, the motivation package includes a selected motivation award 108 in combination with a selected card as the motivation document 102. In another preferred embodiment, the motivation package is a selected motivation award 108 in combination with a selected certificate as the motivation document 102. For example, the award may be baseball tickets and the document may be a thank you for “hitting a home run” in a sales contest.

In one preferred embodiment, the customer selects on-line the motivation package including the motivation document 102 and the motivation award 108. There are at least three scenarios with respect to how the selected document and award come into the possession of the customer and/or the participant: (1) the selected document and selected award are provided to the customer for presentation to the participant; (2) the selected document is provided to the customer for presentation to the participant and the selected award is provided to the participant; or (3) the selected document and selected award are provided to the participant.

There are also several scenarios as to how the documents may be provided (e.g., delivered). The selected document may be sent (delivered) to the customer's location or to the participant's location or both in electronic form for printing. The selected electronic form may be provided (delivered) or be available on-line or as an email attachment or as part of a media such as a CD-ROM or floppy disk.

There are also several scenarios as to how the awards may be delivered. Depending on the type of award selected, the award may be subsequently delivered to the customer or to the participant. If the award is a service, such as a feature redeemable by voucher or a ticket which can be printed, or some other service which can be authorized and/or delivered on-line, the customer or participant may print the details of the award while on-line or have the details of the award delivered to the customer or participant as an email attachment or as part of a media such as a CD-ROM or floppy disk. If the award is a product or other physical item that cannot be delivered on-line, the item is shipped to the customer or participant.

In cases where the document and/or award are provided to the customer, the customer then presents such to the participant. Those skilled in the art will recognize other delivery scenarios.

The following is an example of the first scenario noted above where the customer receives both the document and award for personal presentation to the participant. Initially, the customer selects on-line the motivation package including the motivation document 102 and the motivation award 108. The selected motivation document 102 is subsequently delivered in electronic form to the customer on-line or as an email attachment for printing at the time of selection by the customer or for printing at some later time by the customer prior to the off-line delivery (personal presentation) of the document by the customer to the participant. Depending on the type of award selected, the award is subsequently delivered to the customer. If the award is a feature redeemable by voucher or ticket which can be printed or some other service which can be delivered on-line, the customer may print the details of the award while on-line or have the details of the award delivered to the customer as an email attachment. If the award is a product or other physical item that cannot be delivered on-line, the item is shipped to the customer. After the customer has in her/his physical possession the selected and printed motivation document 102 and the selected motivation award 108, the customer can disseminate the integrated package by personally presenting both simultaneously (or separately) to the participant.

The print software 112 allows the customer to print the motivation document 102 at a destination selected by the customer. In one preferred embodiment, the customer prints the motivation document 102 on a printer local to the customer or participant such as a standard color ink jet printer with the print software 112 supplied by printQuick, Inc. The printQuick, Inc. software is an Internet browser plug-in downloadable via a processor. In an alternative preferred embodiment, the motivation document 102 is printed in other formats such as portable document format (PDF), graphics interchange format (GIF), joint photographic experts group (JPEG), or bitmap format (BMP). In another preferred embodiment, the customer prints the document at a printer which is remote from the customer. For example, the customer may choose to use a commercial location with a sophisticated printer to print the document, in which case the customer would proceed to the print location to retrieve the document.

The vendor software 110 implements delivery of the motivation award 108, e.g., award fulfillment. The motivation award 108 is delivered to the customer for presentation by the customer to the participant or it may be delivered directly to the participant. The vendor software 110 may include credit card software for allowing the customer to purchase the motivation award 108 on-line. The credit card software includes standard e-commerce features such as on-line entry of credit card information, delivery address information, and billing address information. Additionally, the credit card software includes an on-line shopping cart for allowing the customer to designate items to be purchased collectively. The motivation award 108 can then be shipped to the customer for presentation to the participant by the customer.

The motivation awards 108 include non-cash items for participants such as travel packages, a debit card, merchandise awards, or a selective-use “Your Choice®” (YC) card preloaded with a number of award points redeemable for selected products and/or services. The YC card is available in various denominations where one point equals one dollar. Instead of allowing participants to use their award points towards everyday day-to-day expenses, the award points can only be redeemed for selected products and services. In this manner, the participants will be reminded of their achievements after redemption. When a travel package is chosen as the motivation award 108, the customer or participant can select the travel destination. The YC card allows participants to choose their award from an array of merchandise and travel options available via traditional brick-and-mortar stores, telephone ordering, and web ordering.

It is contemplated that the invention may be implemented in software and provided to a customer as a computer-readable media. Although the invention has been described as being available over the Internet, it is contemplated that it may be implemented on the customer's local network.

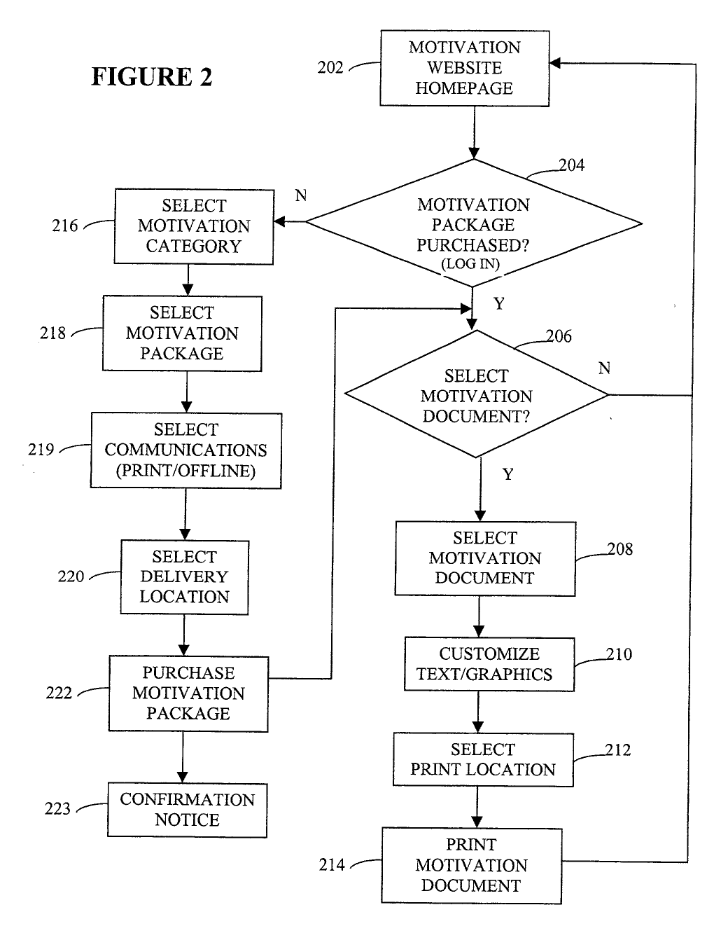

Referring next to FIG. 2, a flow chart of one preferred embodiment of the invention in which the customer selects and customizes a motivation package is illustrated. The order of the steps of FIG. 2 is exemplary and those skilled in the art will recognize that there are many ways to order the steps according to the invention. The customer begins the process of selecting and customizing the motivation package by accessing the homepage 202 of the motivation website 101. If the customer has not previously purchased at 204 a motivation package or wishes to purchase additional motivation packages, the customer is directed to select at 216 a category from a plurality of campaigns and/or motivation packages such as “on-the-spot,” sales contests, retention programs, service anniversary or “holiday gifts”. The customer selects at 218 a motivation package from the previously selected category. The specific motivation document is selected from a collection of available motivation documents and awards for that category of motivation packages (see step 206, below). The customer selects at 219 whether the communications campaign elements (including the motivation documents 102) will be presented to the participant in print form (e.g., hard copy) and/or presented to the participant in electronic form (e.g., on-line or as an email or on a computer readable media) or both. In one preferred embodiment, the type and presentation of the motivation document(s) 102 are dependent upon the motivation package. The motivation documents are available and may be produced following the purchase of the motivation package.

The customer selects at 220 a delivery location (such as an email address only) and purchases at 222 the motivation package. The customer receives at 223 a confirmation notice of the purchase on-line and through email notification. The confirmation notice may provide a link or other access to the motivation documents 102.

After purchasing at 222, the customer is directed to step 206 to begin the process of selecting, customizing and printing the motivation document. At step 206, the customer may select a motivation document 102 immediately or return later through step 204 to select the motivation document 102. To select a motivation document 102, the customer may select at 208 the program appropriate campaign communications element 102. The motivation website 101 may include ideas for personalizing text and/or graphics associated with the motivation documents 102. The customer can optionally customize at 210 the text and/or graphics to indicate the motivation and/or the participant's name. In one preferred embodiment, the graphics are provided by the motivation website 101. Alternatively, graphics are provided by the customer. The customer or the participant customizes the graphics that are then incorporated into the electronic version of the printed document (the communications campaign element). The customer selects at 212 the print location for the motivation document 102, and authorizes printing at 214 or places the electronic version of the document in memory for printing at a later date. In one preferred embodiment, one or more computer-readable media perform the method illustrated in FIG. 2.

From the motivation website homepage 202, the customer can log in at 206 to access a motivation document 102 and proceed as above if the customer previously purchased at 204 a motivation award 108. This case applies when the customer has purchased one or more motivation awards 108, but has not yet printed all the related motivation documents 102. In one preferred embodiment, the customer can return to print the motivation documents 102 up to ninety days after purchase of the motivation awards 108.

There are many ways that the customers can customize the text associated with the motivation documents 102. For example, a card may state “Happy Holidays” and the customer can customize the inside text to read “With your help, we hit our goal!” Alternatively, a certificate may indicate “Certificate of Achievement” and the customer can personalize the text by adding the name of the participant below the graphic header. As another example, promotional postcards may be used to express specific participant achievement and/or recognize team excellence. As another example, the customized text includes recognition of an individual or focus on individual or group achievements or promotion of award opportunity or a specific sales focus.

In one preferred optional embodiment of the invention, the system 100 may include two types of motivation packages: “on-the-spot” and “holiday gift”. “On-the-spot” motivation packages immediately reinforce excellent performance by participants. The on-the-spot motivation packages include a customizable certificate or card as the motivation document 102 and a YC (or other pre-paid, limited use debit) card or a travel package as the motivation award 108. “Holiday gift” packages let the participants know that the customer appreciates their contribution during the holiday season. The holiday gift packages include a customizable card as the motivation document 102 and a YC card or a travel package as the motivation award 108.

In one preferred embodiment of the invention, the motivation document 102 and motivation award 108 are purchased as an integrated motivation package to be delivered to the participant. In this preferred embodiment, the motivation document 102 cannot be purchased without initially purchasing the motivation award 108. While simultaneous delivery of both the document and award of the total motivation package is recommended, the customer can deliver either the motivation document 102 or the motivation award 108 to the participant separately. In general, the motivation award 108 and motivation document 102 can be purchased together or separately and delivered together or separately.

In another preferred embodiment, the customer utilizes the ability to produce off-line, non-electronic communications in a communications campaign associated with a motivation, award, recognition, or incentive program or the like. During such a program, the customer or participant can select on-line (e.g., electronic) or off-line (e.g., paper-based or print-on-demand) communications during the program. The off-line communications can supplant or complement the on-line communications. Selecting on-line or off-line communications can be utilized with methods and systems for electronically selecting, modifying, and operating a motivation program. Elements of the communications campaign which can be delivered on-line or off-line include cards, certificates, announcement pieces, followup mailers (postcards), posters, management and progress reports, launch kits, informational pieces, program letterhead, and t-shirt transfers. The customer can purchase a group of communications campaign elements to be distributed over time to the participants.

The system 100 may include one or more rules structures (see below) for directing the customers to implement a communications campaign which will result in motivating the participants. The rules structures provide direction for use of the program to best motivate the participants and implement the communications campaign.

The following are examples of some of the several optional configurations and alternative preferred embodiments of the invention. The customer selects a merchandise award such as a clock as the motivation award 108 and a certificate as the motivation document 102. The motivation website 101 can also access a participant processor 106 to optionally deliver the motivation document 102 to the participant electronically. The participant processor 106 can be part of any device which is capable of transmitting and receiving data, including, but not limited to, personal computers, laptop computers, handheld personal digital assistants, and cellular telephones. The motivation award 108 can be delivered to the participant as directed by the customer through the motivation website 101. The customer prints the motivation document 102 at a retail document printing company such as Kinko's, Inc. The customer prints or authorizes the printing of the motivation document 102 at a printer local to the participant. The participant is informed of the motivation document 102 (such as by email) and prints the motivation document 102 at a location designated by the participant. The participant can be informed of the motivation document 102 electronically or non-electronically. The award is delivered to the customer for personal presentation to the participant simultaneously or separately from receipt of the document or the award may be delivered directly to the participant. In addition, awards can be independent of communications and need not be tied to communications.

In another preferred embodiment, a customer history database maintains a log of the transactions performed by the customer. These transactions include the type of motivation package purchased, the specific motivation awards 108 purchased within each purchased motivation package, the specific motivation documents 102 printed from the motivation website 101, and the dates of all transactions. The customer history database allows the customers to select motivation packages which are meaningful to the participants and not duplicates from previous years. A reminder service is also available to remind customers of customer-input dates relating to the motivation packages so that the customer does not miss important motivation dates for its participants. The system 100 sends a reminder notice to the customer at the appropriate time electronically (such as emails) or non-electronically (such as paper-based reminders sent via U.S. Mail).

In another preferred embodiment, the system 100 allows the customer to purchase a plurality of motivation awards 108 and print the motivation documents 102 later as needed. Then, the motivation awards 108 would be in hand so the awards could immediately be combined with a motivation document 102 for immediate presentation to a participant. In this preferred embodiment, the customer can provide immediate motivation for a participant.

In a further alternative preferred embodiment, the system 100 may include various motivation packages. For example, the motivation packages may include sales contests, Hit & Win, incremental sales, up to & over, dollar one, anniversary programs, and retention packages. The names of these packages generally correspond to their respective rules structures. Other motivation packages may include top performer, project milestone program, peer-to-peer recognition, group competition program, fast start/fast finish program, safety programs, suggestion programs/system, team competition program, customer satisfaction research, training, top stop program, plateau-based program package, SKU-level motivation package (multiple products/different spend rates), and multiple metrics at an individual level combined with team metrics motivation package.

The following are exemplary of some of the rules structures that may be implemented for such programs: sales contests (highest sellers get motivation packages), Hit & Win (achieve a certain level and win a motivation package), incremental sales (for each increment, a motivation package is awarded), up to & over (a package is awarded for a percentage increase), dollar one (a point program), anniversary programs (a package for each anniversary), and retention packages (packages for longevity), top performer (best performer gets a package), project milestone program (packages for each milestone reached), peer-to-peer recognition (peers vote to give packages), group competition program (a successful group is rewarded as a group), fast start/fast finish program (first to reach a preliminary goal and/or first to finish is rewarded), safety programs (packages for exemplary safety records), suggestion programs/systems (packages for suggestions), team competition program (packages for winning teams), customer satisfaction research (packages for having satisfied customers), training (packages for completing training), top stop program (packages for reaching a top goal), plateau-based program package (packages for maintaining a certain level), SKU-level motivation package (multiple products/different spend rates), and multiple programs (e.g., multiple metrics at an individual level combined with team metrics motivation package).

In a further alternative preferred embodiment, the system 100 includes various communications campaign elements. Some of the communications campaign elements may only be available with certain motivation packages. For example, the communications campaign elements that may be selected, customized, and printed include program announcements, promotional mailers (throughout program duration; including program end), award account statements, participant progress reports, program manager summary reports, program letterhead, certificates (recognition), congratulations letters/mailers, postcards, team results, posters (i.e., program promotion; safety tracking; etc.), management summary reports (roll up from program manager), client ability to customize elements of communications and print (in support of product needs, etc.), cards (i.e., greeting; inspirational; congratulatory; recognition-based; etc.), launch kits (may include such things as banners, flyers, t-shirt transfers, etc.), sales brochures (i.e., print the tutorial/tour; general, by award type, product type, etc.), and step-up catalog poster (other award promotional pieces; i.e., mini-catalogs, travel brochures, etc.).

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A system comprising:
an on-line motivation website for implementing a motivation program allowing a customer to motivate a participant by selecting and providing to the participant an award and a printable communications campaign element;
a fulfillment program for providing the selected award to the participant either directly or through the customer; and
a printing program associated with the website for creating a printed version of the selected communications campaign element for off-line presentation to the participant.

2. The system of claim 1, wherein the printing program permits the communications campaign elements to be customized on-line by the customer prior to printing and off-line presentation.

3. The system of claim 1 wherein the communications campaign element refers to the selected award and further comprising a customer history database maintaining a log of the transactions performed by the customer.

4. The system of claim 1, wherein the website allows the customer to select the communications campaign element from a group comprising promotional mailers, award account statements, participant progress reports, and greeting cards.

5. A method comprising:
providing an on-line motivation program for allowing a customer to motivate a participant by providing an award to the participant; and
allowing a customer to select at least one communications campaign element associated with the motivation program for off-line presentation to the participant.

6. The method of claim 5, further comprising allowing the customer to customize the selected communications campaign element prior to presentation to the participant.

7. The method of claim 5, further comprising allowing the customer or participant to print the selected communications campaign elements at a designated location.

8. The system of claim 5 wherein the communications campaign element refers to the selected award.

9. One or more computer-readable media for performing the method recited in claim 5.

10. The method of claim 5, further comprising a plurality of rules structures for directing the customer to implement a communications campaign which will result in motivating the participants.

11. A method for allowing a customer to motivate a participant by presenting to the participant one of a plurality of motivation packages customized by the customer, said method comprising the steps of:
allowing the customer to select via a website accessible on-line one of a plurality of motivation documents to be presented to the participant and to select via the website accessible on-line one of a plurality of motivation awards to be presented to the participant;
allowing the customer to print the selected motivation document at a location designated by the customer or a location designated by the participant wherein the selected motivation document includes customized text indicating the motivation award and/or text indicating the participant's name; and
implementing the delivery of the selected motivation award to the customer or to the participant.

12. The method of claim 11, further comprising a plurality of rules structures for directing the customers to implement a communications campaign which will result in motivating the participants.

13. One or more computer-readable media for performing the method recited in claim 11.

14. The method of claim 11 further comprising allowing the customer to customize the selected communications campaign element and wherein the customized text includes recognition of an individual or focus on achievements or promotion of award opportunity or a specific sales focus.

15. A system for allowing a customer to motivate a participant with an on-line motivation program, said system comprising:
a plurality of communications campaign elements in electronic format;
a website accessible on-line by the customer for allowing the customer to select one of the communications campaign elements to be presented to the participant; and
software responsive to the customer's on-line selections for printing the selected communications campaign elements at a location designated by the customer or a location designated by the participant, wherein the printed communications campaign element is provided to the participant and wherein the printed communications campaign elements includes text indicating the motivation and/or text indicating the participant's name.

16. The system of claim 15, wherein the communications campaign elements comprise motivation documents.

17. The system of claim 15 further comprising a plurality of awards and wherein the website allows the customer to select at least one of the awards to be provided to the participant and further comprising a fulfillment system for providing the selected award to the participant.

18. The system of claim 15 wherein the software allows the customer to customize the selected communications campaign element prior to being provided to the participant.

19. A motivation program comprising:
a first program for permitting a customer to select on-line a motivation award for a participant and for permitting the customer to select on-line a communications campaign element for the participant;
a second program for arranging to have the selected motivation award delivered to the customer or to the participant; and
a third program for printing the selected communications campaign element at a designated location for delivery off-line to the participant.

20. The motivation program of claim 19 wherein the communications campaign element refers to the selected award and further comprising a program to allow the customer to customize the selected communications campaign element.

21. A method for allowing a customer to motivate participants, said method comprising the steps of:
allowing the customer to select via a website accessible on-line a category of campaigns and/or motivational programs;
allowing the customer to select one of a plurality of motivation documents related to the selected category, the selected document to be presented to the participants; and
allowing the customer to print the selected motivation document at a location designated by the customer or a location designated by the participant receiving the document wherein the selected motivation document includes customized text relating to motivation of the participant and/or text indicating the name of the participant receiving the document.

22. The method of claim 21 further comprising the steps of:
allowing the customer to select via the website accessible on-line one of a plurality of motivation awards to be presented to a selected one or more of the participants; and
implementing the delivery of a selected motivation award to the customer for presentation to the selected participant or implementing the delivery of a selected motivation award to the selected participant.

23. A promotional campaign system for allowing a customer to motivate participants, said system comprising:
a website accessible to the customer on-line for allowing the customer to:
(1) select a category of campaigns and/or motivational programs; and
(2) select one of a plurality of motivation documents related to the selected category, the selected document to be presented to at least some of the participants; and
software allowing the customer to print the selected motivation document at a location designated by the customer or a location designated by the participant receiving the document wherein the selected motivation document includes customized text relating to motivation of the participant and/or text indicating the name of the participant receiving the document.

24. The system of claim 23:
wherein the website allows the customer to select via the website accessible on-line one of a plurality of motivation awards to be presented to a selected one or more of the participants; and
further comprising software implementing the delivery of a selected motivation award to the customer for presentation to the selected participant or software implementing the delivery of a selected motivation award to the selected participant.
